(19) United States
(12) Patent Application Publication
(10) Pub. No.: US 2016/0160553 A1
(43) Pub. Date: Jun. 9, 2016

(54) AUTOMATIC DUAL ELECTRIC MOTOR TAILGATE LIFT SYSTEM

(71) Applicant: FORD GLOBAL TECHNOLOGIES, LLC, Dearborn, MI (US)

(72) Inventor: Adrian Nania, Rochester, MI (US)

(21) Appl. No.: 14/560,242

(22) Filed: Dec. 4, 2014

(51) Int. Cl. E05F 15/627; E06B 3/38; B62D 33/027

(52) U.S. Cl. CPC E05F 15/627; B62D 33/0273; E06B 3/38; E05Y 2201/41; E05Y 2201/434; E05Y 2201/654; E05Y 2900/546; E05Y 2900/516

(57) ABSTRACT

A motor vehicle tailgate power lift system for displacing a motor vehicle tailgate between a closed position and at least one open position includes a first actuator for lengthening and shortening a first stay cable attached to a first tailgate side and a second actuator for lengthening and shortening a second stay cable attached to a second, opposed tailgate side. First and second sensors disposed on a motor vehicle body to which the tailgate is hingedly attached independently detect a latching operation of a first tailgate latch and a second tailgate latch. A controller is responsive to the first and second sensor to operate the first and second actuators when closing the tailgate, thereby adjusting for any tailgate to vehicle body misalignment.

### TECHNICAL FIELD

This disclosure relates generally to truck tailgate lift systems, and more particularly to a dual cable driven power tailgate for a pickup truck or other such vehicle. The described system is robust, allowing compensation for tailgate-vehicle bed misalignment while requiring use of smaller motors, and can be retrofitted to most vehicles without increasing tailgate mass or significantly reducing vehicle bed space.

### BACKGROUND

It is known to provide power lift systems for tailgates, for example for pickup trucks. Such systems allow raising and lowering the vehicle tailgate without a user actually having to physically lift/lower the tailgate. This adds a convenience factor, as the user is able to raise/lower the tailgate without, for example, having to set down any packages he or she may be carrying. Still further, such systems aid the physically impaired, who may have difficulty physically raising or lowering a heavy vehicle tailgate.

However, conventional systems suffer from various disadvantages. They may be complex and require additional components integrated into the tailgate itself, increasing the weight and cost of manufacture of the tailgate. Additionally, conventional tailgates are hinged to pivot at a bottom when raised or lowered. Typically, the latch assemblies for securing the tailgate in the closed position are disposed at the top corners of the tailgate/pickup bed. Conventional powered tailgate systems therefore require significant application of force in order to raise a tailgate and to cause it to latch. Additionally, conventional power tailgate systems lack a mechanism for compensating for tailgate/vehicle bed misalignment. That is, the conventional power tailgate system is required to ensure that each latch operates concurrently. If misalignment of the tailgate/vehicle bed occurs, it is possible that the tailgate will not properly latch to the vehicle bed.

To solve these and other problems, the present disclosure describes a dual motor tailgate power lift system. Advantageously, the disclosed system provides a simple, robust mechanism to compensate for potential tailgate/vehicle latch misalignment. By the disclosed system design, lesser force is required to latch the tailgate to the vehicle bed than conventional power lift systems. Moreover, the disclosed tailgate power lift system is configured to provide a variety of “down” positions in addition to fully raised or fully lowered, to allow retention of oversized loads that do not allow the tailgate to fully close.

### SUMMARY

In accordance with the purposes and benefits described herein, a motor vehicle tailgate power lift system for displacing a motor vehicle tailgate between a closed position and at least one open position is provided, including a first actuator for lengthening and shortening a first stay cable attached to a first tailgate side and a second actuator for lengthening and shortening a second stay cable attached to a second, opposed tailgate side. First and second sensors disposed on a motor vehicle body to which the tailgate is hingedly attached separately detect a latching operation of a first tailgate latch and a second tailgate latch.

The first actuator and the second actuator each include a motor operatively connected to a cable drum for lengthening and shortening a stay cable, and are disposed on opposed top rear portions of the motor vehicle body. By this configuration, the first stay cable and second stay cable are shortened by spooling onto the respective first and second cable drums whereby the first and second stay cable are oriented substantially horizontally to a plane defined by the motor vehicle body as the tailgate is pulled into a closed, latching position. In turn, the first and second actuators are each controlled to displace the tailgate to a plurality of partially open configurations. In an embodiment, one of the plurality of partially open configurations is a pre-programmed tailgate removal configuration. In another embodiment, one of the actuators is slaved to the other actuator, to ensure that both operate during a particular controlled action. A variety of controllers may be provided for controlling the first and second actuator, including without limitation a controller associated with a tailgate latch handle mechanism, a foot-operated controller, a controller associated with a user key fob, and the like.

In another aspect, a method for displacing a motor vehicle tailgate between a closed position and at least one open position is provided. The method includes providing first and second actuators as described above for lengthening and shortening stay cables to displace the tailgate between a closed position and at least one open position. The at least one open position may include a pre-programmed tailgate removal position, a partially closed configuration allowing carrying oversized loads in the motor vehicle, and others.

First and second sensors are provided for independently detecting a latching operation of a first tailgate latch and a second tailgate latch. The first and second sensors may be disposed on the motor vehicle body or on the tailgate. In use, each of the first and second actuators are caused to independently shorten the first stay cable and the second stay cable until each of the first and second sensors independently signals a completed latching operation for each of the first tailgate latch and the second tailgate latch. In embodiments, the first actuator and the second actuator are disposed on opposed top rear portions of the motor vehicle body to which the tailgate is hingedly attached. The first stay cable and second stay cable are shortened by spooling onto respective first and second cable drums driven by first and second motors. As the tailgate approaches the closed position the stay cables are oriented substantially horizontally to a plane defined by the body to pull the tailgate to an upright latching position. One or more controllers may be provided as described above for controlling the first and second actuators to displace the tailgate between the closed position and the one or more open positions.

In yet another aspect, a motor vehicle tailgate power lift system is provided, including a tailgate having an edge hingedly connected to a motor vehicle body, a first stay cable at a first tailgate side, and a second stay cable at a second tailgate side. A first actuator is provided for lengthening and shortening the first stay cable, and a second actuator is provided for lengthening and shortening the second stay cable to displace the tailgate between the closed position and the at least one open position. A controller is provided for controlling operation of the first and second actuators. A first latch is provided at a first side of the motor vehicle body and a second latch is provided at a second side of the motor vehicle body. A first latch sensor monitors whether the first latch is in a latched or unlatched condition, and a second latch sensor monitors whether the second latch is in a latched or unlatched condition. The controller is responsive to the first and second sensor to operate the first and second actuators when closing the tailgate, thereby adjusting for any tailgate to vehicle body misalignment.

In the following description, there are shown and described embodiments of the disclosed motor vehicle tailgate power lift system. As it should be realized, the motor vehicle tailgate power lift system is capable of other, different embodiments and its several details are capable of modification in various, obvious aspects all without departing from the armrest device as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed tailgate power lift system, and together with the description serve to explain certain principles thereof. In the drawing:

FIG. 1 is a top view of a pickup truck bed including a tailgate power lift system according to the present disclosure;

FIG. 2 is a side view of the pickup truck bed of FIG. 1, showing various partially open positions of a tailgate;

FIG. 3 illustrates operation of the tailgate power lift system of FIG. 1, with FIG. 3A showing the tailgate in the down position and FIG. 3B showing the tailgate in the up position;

FIG. 4 is a top view of a side of the tailgate power lift system of FIG. 3, with FIG. 4A showing the tailgate in the up position and FIG. 4B showing the tailgate in the down position; and

FIG. 5 illustrates a latch for a pickup tailgate according to the present disclosure including a latching sensor; and

FIG. 6 shows in electrical block diagram form various elements of and means for controlling the system described in the present disclosure.

Reference will now be made in detail to embodiments of the disclosed tailgate power lift system, examples of which are illustrated in the accompanying drawing figures.

### DETAILED DESCRIPTION

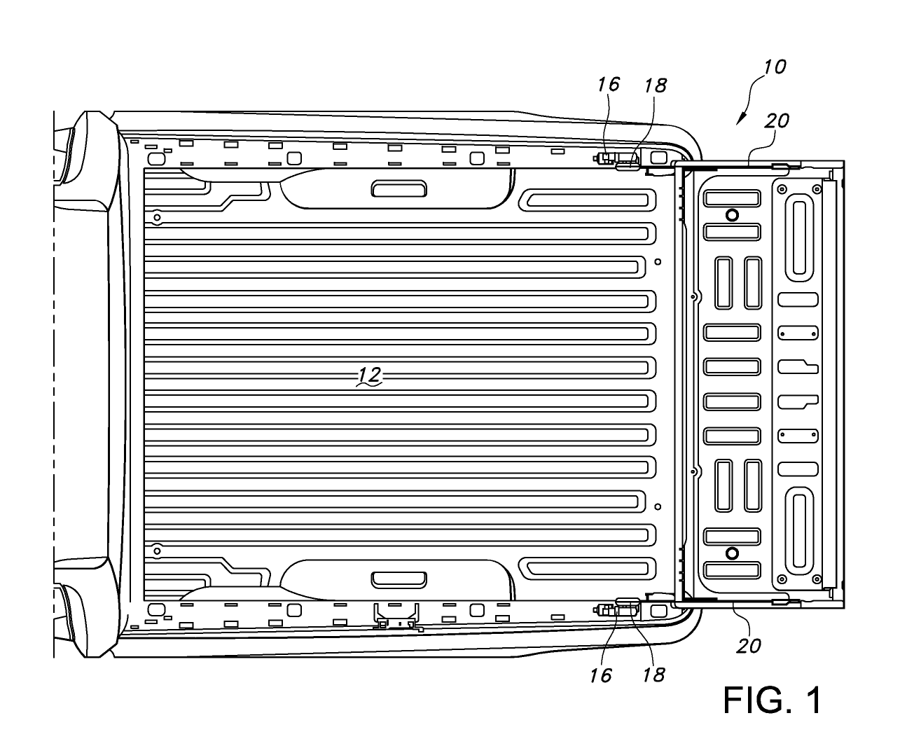

Reference is now made to FIG. 1 illustrating a tailgate power lift system 10. The system 10 is adapted to be included in a substantially conventional motor vehicle having a hingedly attached tailgate, or alternatively to be retrofitted to such a vehicle. In the depicted embodiment, the system 10 is incorporated into a pickup truck having a load-carrying bed 12 and a tailgate 14 which is hinged to pivot at a bottom surface thereof for raising and lowering. However, it will be appreciated that the system 10 can be incorporated into any vehicle incorporating such a tailgate 14. As shown, all or substantially all the system 10 can be disposed within the confines of in a bed 12 sidewall and/or under a bed 12 liner (not shown), thus reducing the profile of the system 10 and avoiding use of the load-carrying space of the vehicle. A further advantage is that while the system 10 is connected to the tailgate 14 as will be described below, the system 10 is otherwise separate from the tailgate 14 and does not add to the tailgate 14 mass. Thus, the system 10 can be connected to any standard, original equipment tailgate 14 provided with a vehicle.

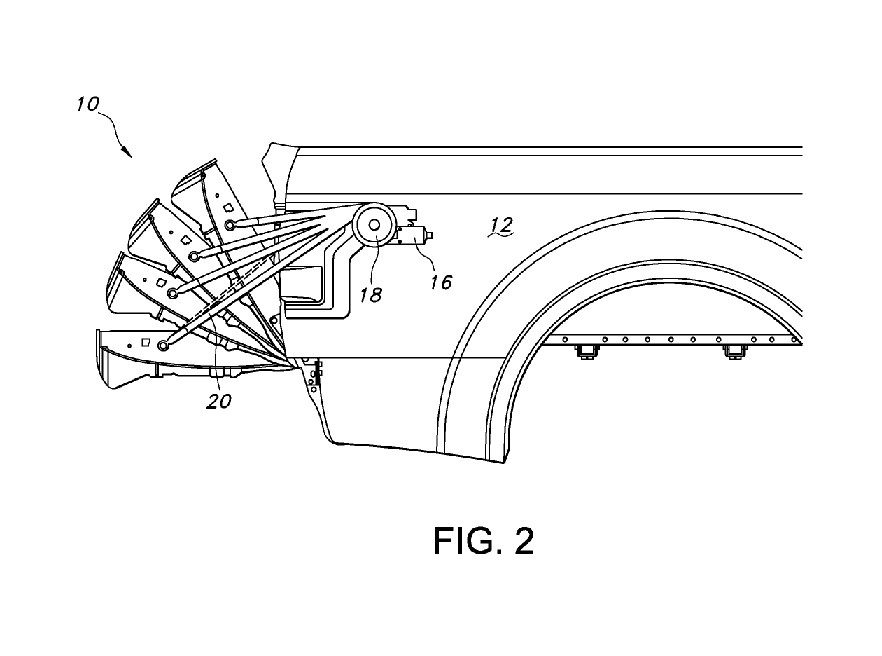

The system 10 includes a pair of electric drive motors 16 actuating cooperating cable drums 18. Cable drums 18 rotate to spool/unspool stay cables 20 and so to shorten or lengthen stay cables 20. As shown in FIG. 2, the electric drive motors 16 rotate cable drums 18 in a first direction to unspool and lengthen stay cables 20 and lower the tailgate 14, and rotate cable drums 18 in a second, opposed direction to spool and shorten stay cables 20 and raise the tailgate 14. It will be appreciated that the motors 16 can be disposed within a perimeter of the bed 12 and that only cable drums 18 must be exposed from the bed 12, to allow attachment of the stay cables 20 thereto. Because all of the moving parts of the described system 10 are maintained in the bed 12, it will also be appreciated that manual raising/lowering of the tailgate 14 without using the described system 10, removal of the tailgate 14 from the bed 12, etc. remain possible at the user's whim.

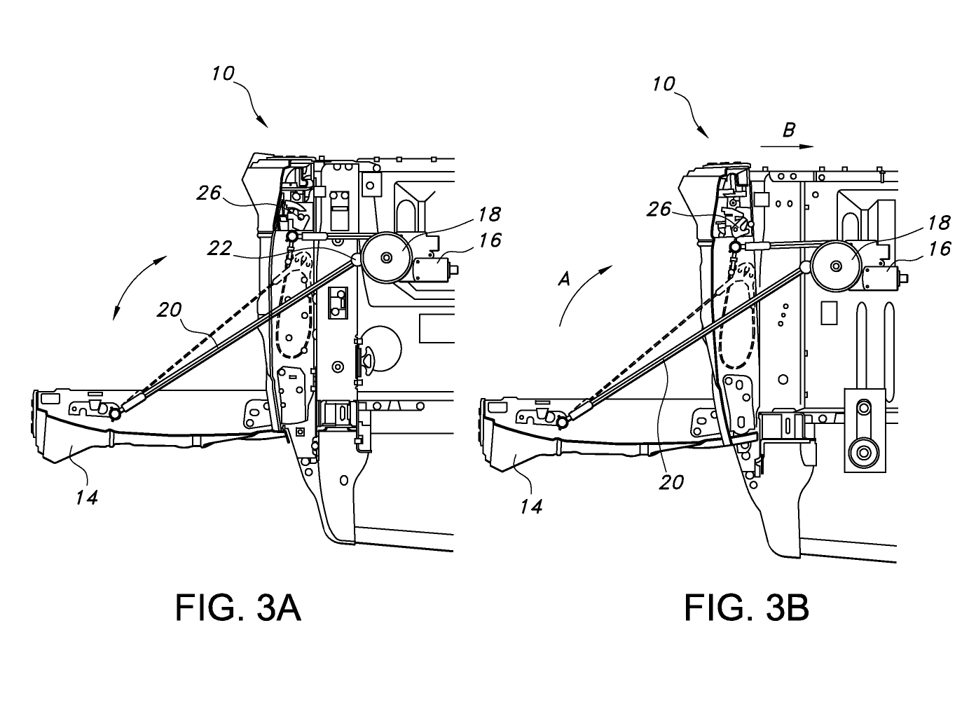

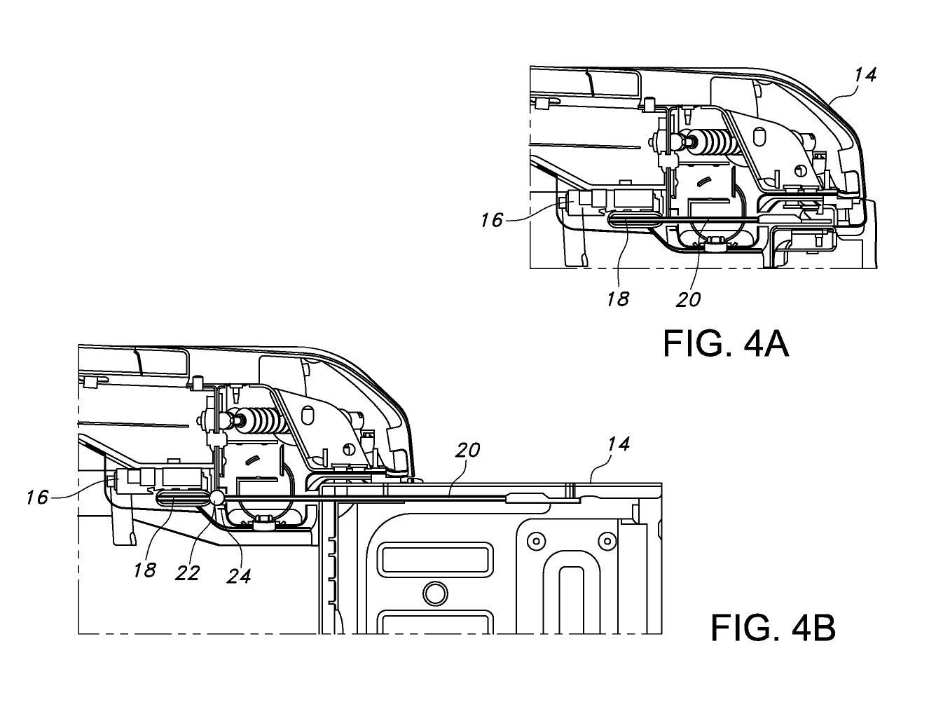

A lock ball 22 (see FIG. 3A) associated with each stay cable 20 inserts into a slot 24 (see FIGS. 4A and 4B) as cable drums 18 unspool stay cables 20 to lower the tailgate 14 to the fully open position (see FIG. 3A), preventing further travel of the tailgate 14. When the tailgate 14 is in the fully closed position, the lock balls 22 are spooled onto the cable drums 18 (see FIG. 4A).

When the tailgate 14 is in the fully lowered, open position (FIG. 3A), cables 20 are held at an angle that is similar to that of conventional, non-motorized stay cables (depicted in broken lines) as are known in the art. On the other hand, as motors 16 rotate cable drums 18 to spool stay cables 20 and to raise the tailgate 14 to the closed position, an advantage of the present system 10 is revealed. As can be seen in FIG. 3B, as the tailgate 14 pivots to the fully upright, closed position (see arrow A) and the top of the tailgate 14 approaches the bed 12, the stay cables 20 assume a horizontal or near-horizontal configuration as the cables spool onto drums 18 and the tailgate 14 is pressed against a latching mechanism 24. By this feature, all or substantially all of the latching force is applied in a horizontal direction (see arrow B) compared to the direction that force is applied using a conventional power lift system disposed at the hinged end of tailgate 14. That is, a “straight pull” of the tailgate 14 into paired latching mechanisms 26 using stay cables 20 increases latching efficiency, because smaller motors 16 can be used to apply the required amount of force to latch tailgate 14 compared to the larger motors that would be required to latch a tailgate 14 using a power system at the hinged end of tailgate 14.

In the depicted embodiments, the motors 16 are “smart” electric motors, that is, they are configured for pre-programming or “training” to perform a variety of operations. Such motors are well-known to the skilled artisan in the motor vehicle arts, for example in the sunroof and power side door fields, and so need not be further described herein. Example operations (pre-programmed or operator switch/button actuated) include the fully open and fully closed positions for tailgate 14 as described above. Further, the motors 16 can be programmed to spool the stay cables 20 on drums 18 at a reduced speed as tailgate 14 approaches the fully upright, closed position, to reduce the impact of closing the tailgate 14. This eliminates any need for pinch strips and/or pinch sensors as are required for conventional power tailgate/door assemblies to ensure that sufficient force is applied to a latching operation.

In addition, the motors 16 can be configured to spool/unspool stay cables 20 to place tailgate 14 in a variety of partially open configurations (see FIG. 2), or alternatively can be caused to achieve these configurations by inclusion of an operator-usable switch/button (not shown) which causes the motors 16 to spool or unspool the stay cables 20 only as long as the operator is actuating the switch. By this feature, retention of oversized loads that do not allow tailgate 14 to pivot to the fully closed position is possible.

In the depicted embodiments, two electric “smart” motors 16 are provided, one associated with a left rear portion of the bed 12 and one associated with a right rear portion of the bed 12. Each motor 16 is responsible for raising/lowering one side of the tailgate 14 by spooling/unspooling stay cables 20. The motors 16 may be slaved one to the other, that is, when one motor 16 is actuated to spool or unspool stay cable 20, the other motor follows suit to raise or lower the tailgate 14. However, each motor 16 operates to latch a side of the tailgate 14 independently. That is, each motor 16 will continue to spool its associated stay cable 20 onto its associated cable drum 18 until its associated latch (described in greater detail below) is fully latched and the tailgate 14 is secured in the closed position.

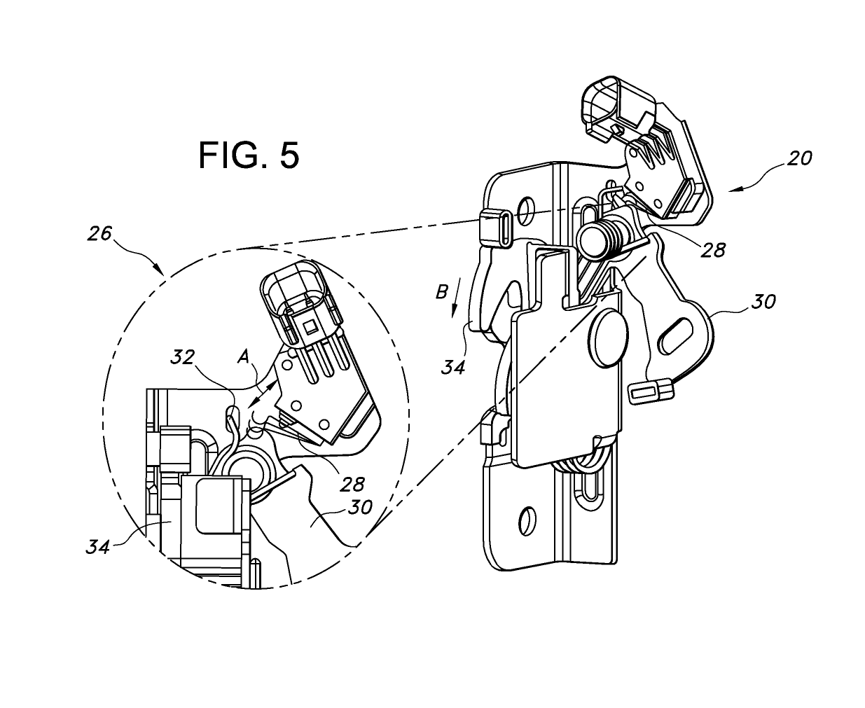

Each latching mechanism 26 includes a “tailgate ajar” switch 28 in electrical communication with a motor 16, by which each motor 16 verifies whether the latching mechanism 26 has latched and tailgate 14 is in the closed position. In the depicted embodiment (see FIG. 5) switch 28 is a simple contact switch. An arm 30 is biased to an “open” position, such as by a spring clip 32, whenever tailgate 14 is not in the fully closed and latched position. As tailgate 14 approaches the fully closed position, it contacts and biases arm 30 which in turn biases a latching hook 34 forward (see arrow B) to engage a pin (not shown) associated with tailgate 14. Concurrently, arm 30 biases contact switch 28 (see arrow A) to close the contact, signaling motor 16 that the tailgate 14 is fully closed. Motor 16 then ceases spooling stay cable 20 onto cable drum 18, thus completing the latching operation. This process occurs independently for each of the two latching mechanisms 26, thus ensuring that both sides of tailgate 14 are fully latched. Advantageously, by this mechanism any misalignment of the tailgate 14 and the bed 12 which may occur during a tailgate 14 closing operation (for example, one side of the tailgate 14 latching slightly earlier than the other) is automatically compensated for and synching automatic power latches are not required.

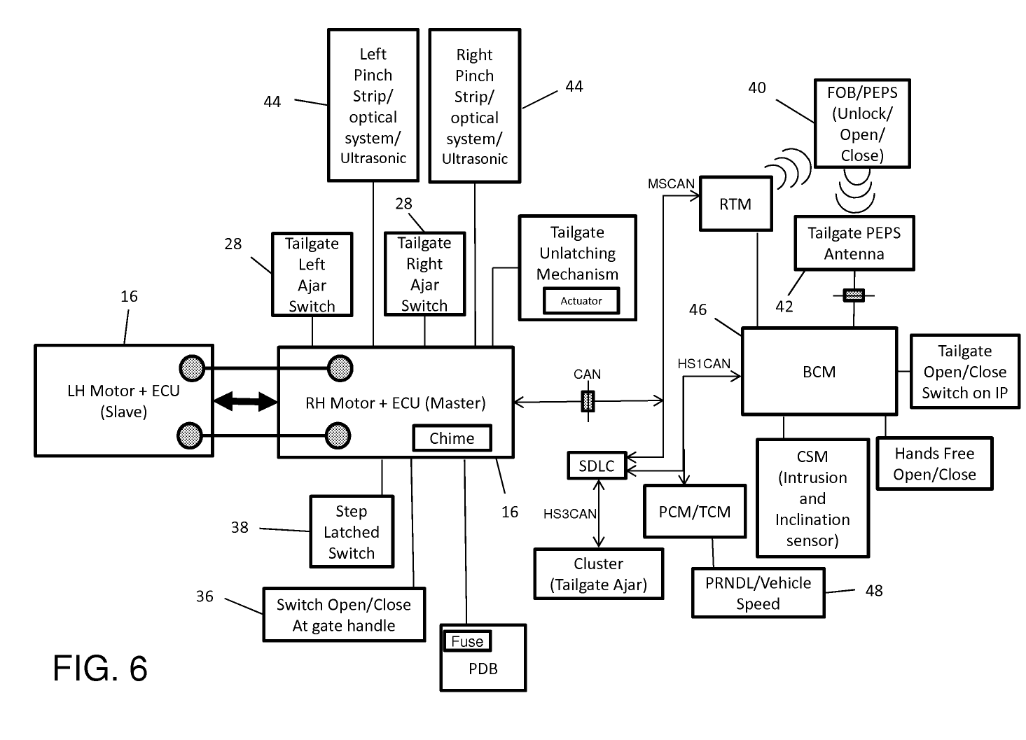

A variety of actuator mechanisms for operating the disclosed system 10 are contemplated. As non-limiting examples (see FIG. 6), an actuator may be incorporated into the tailgate unlatching handle 36. Alternatively or in addition, a step-latched switch 38 may be included. Also alternatively or in addition, wireless actuators such as lock/unlock buttons may be incorporated into the users' key fob 40, transmitting a lock/unlock signal to an antenna 42 incorporated into the tailgate 14. This may be a conventional key fob, a passive entry-passive start (PEPS) actuator, or other such systems. Optionally, pinch strips/optical system/ultrasonic sensors 44 may be included to sense obstructions in the path of tailgate 14 as it is opened and closed in the manner described above. Such mechanisms are known to the skilled artisan, and require no further description herein.

A body control module (BCM) 46 may be included to provide the motor vehicle with an interactive information, diagnostic, entertainment, and wired/wireless communication system which, as part of its operation, monitors and displays information regarding operation of the presently disclosed system 10. Such BCMs are described in, for example, U.S. Pat. No. 6,240,347 and marketed as the FORD SYNC system. The BCM 46 may integrate with other vehicle systems. For example, the BCM 46 may communicate by wired means or wireless means, as appropriate, with a vehicle speed sensor 48 to prevent operation of tailgate 14 when the vehicle is in motion (i.e., vehicle speed is greater than 0), when the vehicle transmission is engaged (that is, vehicle transmission is set in “park”), when the BCM 46 cannot locate the PEP key, etc.

In summary, numerous benefits are provided by the described tailgate power lift system 10. As should be appreciated, the system provides the advantages of automated raising/lowering of a motor vehicle tailgate 14 without requiring adding mass to the tailgate, and can be retrofitted to existing vehicles. Dual motors 16 which, while slaved together for operation, independently ensure full latching of both sides of tailgate 14 allow automated compensation for any tailgate 14/bed 12 misalignment encountered during a closing/latching process. In turn, the configuration of system 10 to provide a substantially horizontal configuration of stay cables 20 as tailgate 14 reaches the fully raised and latching position immediately prior to latching allows application of an increased, “straight pull” latching force using a smaller motor than would be possible using a power system at the hinged end of tailgate 14 to raise and lower the tailgate.

Still more, use of so-called “smart” motors allows a variety of additional operations in addition to fully raising or lowering tailgate 14. For example, the motors may be pre-programmed for a slower rate of spooling/unspooling of stay cables 20 as the tailgate 14 approaches the fully raised and/or fully lowered position to prevent undue impact and damage. Also, the motors 16 may be pre-programmed or later “trained” to perform a partial raising operation of tailgate 14, allowing retention of oversized loads.

The foregoing disclosure has been presented for purposes of illustration and description. It is not intended to be exhaustive or to limit the embodiments to the precise form disclosed. Obvious modifications and variations are possible in light of the above teachings, and all such modifications and variations are within the scope of the appended claims when interpreted in accordance with the breadth to which they are fairly, legally and equitably entitled.

1. A motor vehicle tailgate power lift system for displacing a motor vehicle tailgate between a closed position and at least one open position, comprising:
a first motor for lengthening and shortening a first stay cable attached to a first tailgate side; and
a second motor for lengthening and shortening a second stay cable attached to a second, opposed tailgate side.

2. The system of claim 1, further including first and second sensors for detecting a latching operation of a first tailgate latch and a second tailgate latch.

3. The system of claim 1, wherein each of the first motor and the second motor is operatively connected to a cable drum for lengthening and shortening the stay cables.

4. The system of claim 3, wherein the first motor and the second motor are disposed on opposed top rear portions of the motor vehicle body sides whereby the first stay cable and second stay cable are shortened by spooling onto respective first and second cable drums to displace the tailgate to a closed, latching position.

5. The system of claim 1, wherein the first motor and the second motor each are controlled to displace the tailgate to a plurality of partially open configurations.

6. The system of claim 1, wherein one of the plurality of partially open configurations is a pre-determined tailgate removal configuration.

7. The system of claim 1, wherein operation of the first motor is slaved to operation of the second motor.

8. The system of claim 7, further including one or more actuators for causing the first actuator and the second actuator to lengthen or shorten the first and second stay cables to displace the tailgate between the closed position and the at least one open position.

9. A motor vehicle including the tailgate power lift system of claim 1.

10. In a motor vehicle including a body and a motor vehicle tailgate hingedly attached to that body, a method for displacing the motor vehicle tailgate between a closed position and at least one open position, comprising:
providing a first motor for lengthening and shortening a first stay cable attached to a first tailgate side;
providing a second motor for lengthening and shortening a second stay cable attached to a second, opposed tailgate side; and
by said first and second motor, lengthening or shortening the first and second stay cable to displace the motor vehicle tailgate between the closed position and the at least one open position.

11. The method of claim 10, further including providing first and second sensors for detecting a latching operation of a first tailgate latch and a second tailgate latch.

12. The method of claim 11, further including connecting each motor to a cable drum for lengthening or shortening the first and second stay cable.

13. The method of claim 12, further including causing the first motor and the second motor to independently shorten the first stay cable and the second stay cable until each of the first and second sensors independently signals a completed latching operation for each of the first tailgate latch and the second tailgate latch.

14. The method of claim 12, further including disposing the first motor and the second motor on opposed top rear portions of the motor vehicle body to which the tailgate is hingedly attached, whereby the first stay cable and second stay cable are shortened by spooling onto the respective first and second cable drums to displace the tailgate to a closed, latching position.

15. The method of claim 10, further including controlling the first motor and the second motor to displace the tailgate to a plurality of partially open configurations.

16. The method of claim 15, wherein one of the plurality of partially open configurations is a tailgate removal configuration

17. The method of claim 10, further including slaving operation of the first motor to operation of the second motor.

18. The method of claim 10, further including providing one or more actuators for causing the first motor and the second motor to lengthen or shorten the first and second stay cables to displace the tailgate between the closed position and the at least one open position.

19. A motor vehicle tailgate power lift system, comprising:
a tailgate having an edge hingedly connected to a motor vehicle body;
a first stay cable at a first tailgate side;
a second stay cable at a second tailgate side;
a first motor for lengthening and shortening the first stay cable;
a second motor for lengthening and shortening the second stay cable; and
an actuator for controlling operation of the first and second motors.

20. The system of claim 19, further including a first latch at a first side of the motor vehicle body, a second latch at a second side of the motor vehicle body, a first latch sensor for monitoring whether the first latch is in a latched or unlatched condition, and a second latch sensor for monitoring whether the second latch is in a latched or unlatched condition;
wherein the actuator is responsive to the first and second sensor to operate the first and second actuators when closing the tailgate, thereby adjusting for any tailgate to vehicle body misalignment.
